(19) United States
(12) Patent Application Publication
(10) Pub. No.: US 2007/0236699 A1
(43) Pub. Date: Oct. 11, 2007

(54) Optical tomography method & device

(75) Inventors: Chien Chou, Taipei City (TW); Wen-Chuan Kuo, Taipei City (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Chien Chou, Taipei City (TW)

(21) Appl. No.: 11/732,864

(22) Filed: Apr. 4, 2007

(30) Foreign Application Priority Data
Apr. 7, 2006 (TW) 095112404

(51) Int. Cl. G01B 9/02

(52) U.S. Cl. 356/489; 356/479

(57) ABSTRACT

A method for optical tomography is adapted to measure a medium, and includes the following steps: (A) generating a two-frequency mutually correlated low-coherence beam, an optical path difference of the beam being smaller than a coherence length; (B) focusing the beam on different depth positions of the medium such that the beam becomes a signal beam after being reflected by the medium; and (C) analyzing the signal beam reflected by the medium using a signal processing unit that includes a lens and a pinhole located at a focal point of the lens so as to obtain a sectioning image of the medium.

### CROSS-REFERENCE TO RELATED APPLICATION

This application claims priority of Taiwanese Application No. 095112404, filed on Apr. 7, 2006.

### BACKGROUND OF THE INVENTION

1. Field of the Invention

The invention relates to a tomography method and device, more particularly to an optical tomography method and device.

2. Description of the Related Art

Optical coherence tomography (OCT) scanners are currently very useful tomography scanners applied to ophthalmology, dermatology, cardiology, and other related medical diagnosis, because they can provide clear sectioning images required for diagnosing various illnesses. Moreover, compared to other non-invasive medical imaging techniques, such as computer tomography (CT), magnetic resonance imaging (MRI), and ultrasound, OCT can provide a better spatial resolution.

Basically, OCT uses an interferometer with a low-coherence light source. The interferometer will interfere only when an optical path difference between a signal beam and a reference beam is smaller than a coherence length of the light source. Furthermore, because OCT uses a low-coherence light source, the coherence length is very short. Therefore, the optical path difference between the signal beam and the reference beam of the OCT must be much smaller in order for interference to occur so as to obtain a reflected image in the coherence length. Accordingly, the shorter the coherence length, the better will be the axial resolution.

Referring to FIG. 1, a conventional OCT is suitable for measuring a medium 11, and includes a light source 12, a beam splitter 13, a mirror 14, a focusing lens 15, a photo detector 161, and a signal processing unit 162.

The light source 12 emits a low-coherence light beam. The beam splitter 13 is arranged on a beam transmission path for receiving the light beam emitted from the light source 12, and splits the light beam into a signal beam 101 and a reference beam 102 traveling along different transmission paths.

The mirror 14 is arranged on the transmission path of the reference beam 102, can be driven to reciprocate, and is for reflecting the reference beam 102 from the beam splitter 13. The focusing lens 15 is arranged on the transmission path of the signal beam 101 to receive the signal beam 101 from the beam splitter 13, and to focus the signal beam 101 on a certain surface within the medium 11.

The signal processing unit 162 is connected electrically to the photo detector 161. The reference beam 102 reflected by the mirror 14 and the signal beam 101 reflected by the medium 11 pass through the beam splitter 13 once again before being incident on the photo detector 161, and the reference and signal beams 102, 101 are converted to electric signals by the photo detector 161. The signal processing unit 162 is used to analyze the electric signals to obtain a sectioning image of the medium 11.

The signal beam 101 reflected from the medium 11 is reflected from a certain depth position of the medium 11. Therefore, by moving the mirror 14 at a constant speed to change the optical path of the reference beam 102, the optical heterodyne interference signal at a focal point of the focusing lens 15 in the medium 11 can be obtained, thereby acquiring the sectioning image of the medium 11. Specifically, when the optical path difference between the reference beam 102 and the signal beam 101 reflected from a certain depth of the medium 11 is smaller than the coherence length of the light source 12, optical heterodyne interference signal is generated and detected. After analyzing the signals obtained at the respective depths, a three-dimensional sectioning image of the medium 11 can be put together.

Therefore, the axial resolution of the sectioning image is determined by the coherence length of the light source 12, i.e., the shorter the coherence length, the better will be the axial resolution, whereas the lateral resolution is determined by a numerical aperture (NA) of the focusing lens 15. The larger the numerical aperture of the focusing lens 15, the smaller will be the focused light beam, and the better will be the lateral resolution.

Referring to FIG. 2, since the depth of field of the focusing lens 15 is relatively short if the numerical aperture is large, the axial resolution of the sectioning image obtained when there is a slight deviation from the focus of the focusing lens 15 will deteriorate obviously. Therefore, as shown in FIG. 3, the conventional OCT still uses a focusing lens 15 with a small numerical aperture, such as a 20-fold magnification power objective, so that the depth of field can be much longer to ensure that the lateral resolution can be always maintained in the depth of field.

The prior art often uses a conventional super luminescent diode (SLD) as the light source 12, so that the axial resolution is approximately 10-15 μm. Such a resolution can only permit identification of the form of bio-tissue and any mutation in the form of the bio-tissue caused by disease. If it is desired to obtain a real optical biopsy in the bio-cells, such as cancer, a lateral resolution in the order of 1 μm will be required.

In order to enhance the axial resolution, the most direct approach is to use a light source 12 with a broader bandwidth, i.e., a light source 12 with an even shorter coherence length, such as a mode-locked Ti: sapphire laser. Hence, the axial and lateral resolutions can be reduced to 1 μm. However, the laser system is quite expensive and complicated.

In contrast, if we use a focusing lens 15 with a large numerical aperture to enhance the lateral resolution, and in conjunction with a pinhole, i.e., the so-called optical coherence microscopy (OCM), when the coherence gate and a confocal gate formed by the focusing lens 15 and the pinhole overlap at the same time, only the light reflected from the medium 11 at the focal point of the focusing lens 15 can be detected. The light reflected by the medium 11 at defocus positions cannot pass through the pinhole due to a spatial filtering gate formed by the pinhole. Therefore, an axial resolution in the order of 1 μm can be achieved. In addition, since a low-coherence light source is used, a high-resolution sectioning image can be obtained in a scattering medium at a deeper depth compared with a conventional confocal microscope.

However, the use of the focusing lens 15 with a large numerical aperture requires constant overlapping of the coherence gate and the confocal gate in order to obtain optimum signals. Therefore, if it is intended to perform axial scanning, a dynamic focusing approach needs to be adopted in order to enable the coherence gate and the confocal gate to move together.

For instance, the mirror 14 is caused to move synchronously with the focusing lens 15 when the latter is moved back and forth. However, if the refractivity in the medium 11 is not uniform, the optical path of the signal beam 101 will change not only due to movement of the focusing lens 15, but also because of the focusing of the signal beam 101 by the focusing lens 15 in the medium 11 with refractivity variations. Thus, not only is the mirror 14 required to be moved synchronously, it is also necessary to arrange a compensator with the same refractivity as that of the medium 11 on the transmission path of the reference beam 102, so that the optical path difference between the signal and reference beams 101, 102 can be smaller than the coherence length of the light source 12. However, since it is not possible to positively know the changes in the refractivity of the medium 11, only an approximate refractivity can be used as the refractivity of the compensator.

Aberrations and dispersion caused by either the use of the focusing lens 15 with a large numerical aperture or the entering of the signal beam 101 into deeper spots of the medium 11 will result in asymmetry of the respective optical paths of the signal beam 101 and the reference beam 102, so that the wave packet of the heterodyne interference signal is broadened. Consequently, the axial resolution deteriorates.

Furthermore, because the medium 11 will scatter the signal beam 101, especially when the medium 11 is a scattering medium, light reflected from the medium 11 at other depth positions can also pass through the pinhole, thereby resulting in a reduction in the signal to noise ratio (SNR) of the heterodyne interference signal, which affects adversely the quality of the sectioning image.

### SUMMARY OF THE INVENTION

Therefore, an object of the present invention is to provide a method and device for optical tomography, which can reduce scattering effect while reducing aberration and dispersion so as to enhance axial and lateral resolutions of sectioning images in a scattering medium.

Another object of the present invention is to provide a method and device for optical tomography, which can automatically counterbalance aberration and dispersion.

Still another object of the present invention is to provide a method and device for optical tomography, which can reduce the difficulty involved in system installation.

Accordingly, the device for optical tomography of the present invention is adapted to measure a medium, and includes a two-frequency beam generating unit, a relay beam splitter, a focusing lens, and a signal processing unit.

The two-frequency beam generating unit emits a two-frequency mutually correlated photon-pair beam, and includes a light source for emitting a low-coherence beam, a polarizer for receiving the beam emitted from the light source and for producing the received beam into a linear polarized beam, a beam splitter for splitting the beam passing through the polarizer, and two mirrors for respectively receiving and reflecting the split beams from the beam splitter. The two beams that are respectively reflected by the mirrors are caused to further pass through the beam splitter so that transmission paths of the two beams overlap. One of the mirrors is actuated to oscillate at a fixed frequency. The two mirrors are positioned such that an optical path difference between the reflected beams is smaller than a coherence length of the light source.

The relay beam splitter is for receiving and splitting the two-frequency mutually correlated photon-pair beam generated by the two-frequency beam generating unit.

The focusing lens is actuatable to move, and is for receiving a portion of the two-frequency mutually correlated photon-pair beam from the relay beam splitter, and for focusing the portion of the beam on the medium. The portion of the beam is reflected by focal point of lens in the medium to become a signal beam, which is incident on the focusing lens and the relay beam splitter in sequence.

The signal processing unit receives and analyzes the signal beam reflected by the relay beam splitter so as to obtain a sectioning image of the medium, and includes a lens for focusing the signal beam and a pinhole located at a focal point of the lens.

Accordingly, the method for optical tomography of the present invention is adapted to measure a medium, and includes the following steps:

(A) generating a two-frequency mutually correlated photon-pair low-coherence beam from a light source, an optical path difference of the beam being smaller than a coherence length of the light source, one of the beam frequencies being changed as a result of a Doppler effect caused by an oscillating mirror;

(B) focusing the photon-pair beam on different depth positions of the medium along an optical common path, the beam being reflected by the medium to become a heterodyne interference signal beam so that scattering effect, dispersion and aberration can be reduced to enhance quality of a sectioning image; and

(C) analyzing the signal beam reflected by the medium using a signal processing unit that includes a lens and a pinhole located at a focal point of the lens so as to obtain a high spatial resolution sectioning image of the medium.

The present invention employs the principle of heterodyne interference, so that aberration and dispersion of beams with the same transmission path automatically counterbalance each other. Moreover, by using a moving focusing lens to perform axial scanning, the difficulty involved in system installation can be reduced. Besides, a focusing lens with a large numerical aperture can be used to obtain a sectioning image with high lateral resolution, thereby solving the problem of the prior art, which fails to address both the axial resolution and the lateral resolution. In addition, the present invention is particularly suited for measuring a scattering medium due to the depolarization effect in the scattering medium of the two-frequency mutually correlated low-coherence photon pairs, and due to the use of a low-coherence beam. Thus, the scattered low-coherence two-frequency photon-pair beam cannot generate heterodyne interference, thereby reducing the scattering effect by a band pass filter in the signal processing unit. Moreover, since the signal beam is focused via the lens, and since the signal beam reflected by an off-focus plane of the focusing lens is further filtered by the pinhole, the scattering effect can also be reduced to obtain a sectioning image with high axial resolution.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram to illustrate a conventional optical coherence tomography device;

FIG. 2 is a schematic diagram to illustrate that a focusing lens with a large numerical aperture in a conventional optical coherence confocal microscopy device has a relatively short depth of field;

FIG. 3 is a schematic diagram to illustrate that a focusing lens with a small numerical aperture in a conventional optical coherence tomography device has a relatively long depth of field;

FIG. 4 is a schematic diagram to illustrate the first preferred embodiment of an optical tomography method and device of the present invention;

FIG. 5 is a schematic diagram to illustrate the first preferred embodiment when used to obtain a sectioning image of phase retardation of a linear polarized birefringent medium;

FIG. 6 is a schematic diagram to illustrate the second preferred embodiment of an optical tomography method and device according to the present invention;

FIG. 7 is a schematic diagram to illustrate the third preferred embodiment of an optical tomography method and device according to the present invention;

FIG. 8 is a schematic diagram to illustrate the fourth preferred embodiment of an optical tomography method and device according to the present invention; and

FIG. 9 is a schematic diagram to illustrate that a focusing lens with a large numerical aperture in the present invention has a relatively short depth of field overlapping with a coherence gate.

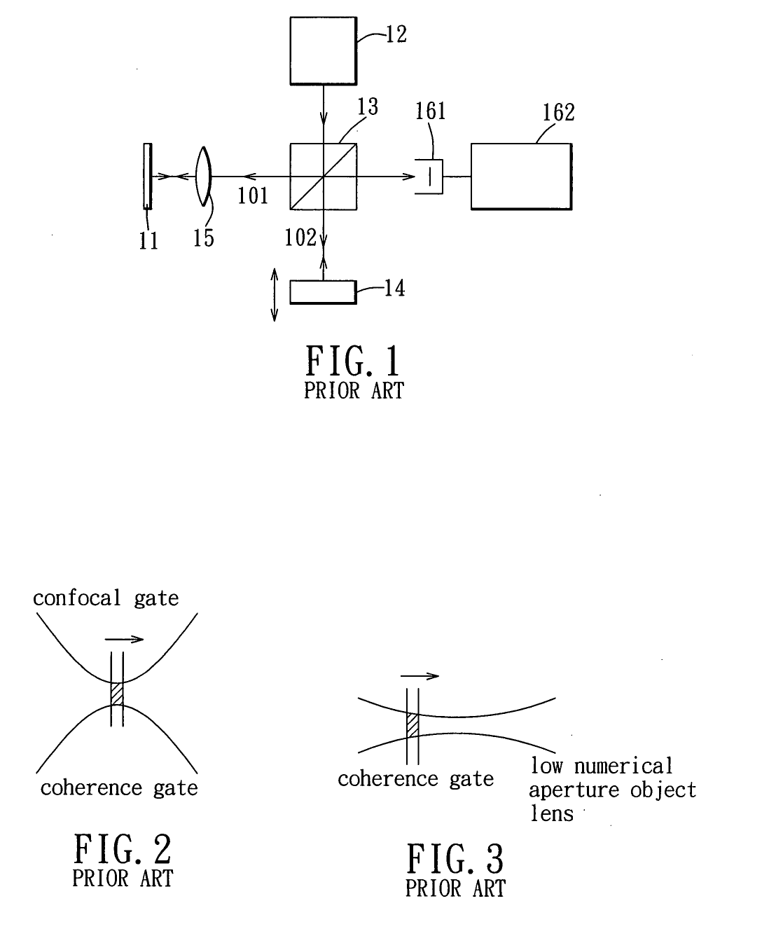

### DETAILED DESCRIPTION OF THE PREFERRED EMBODIMENTS

Before the present invention is described in greater detail, it should be noted that like elements are denoted by the same reference numerals throughout the disclosure.

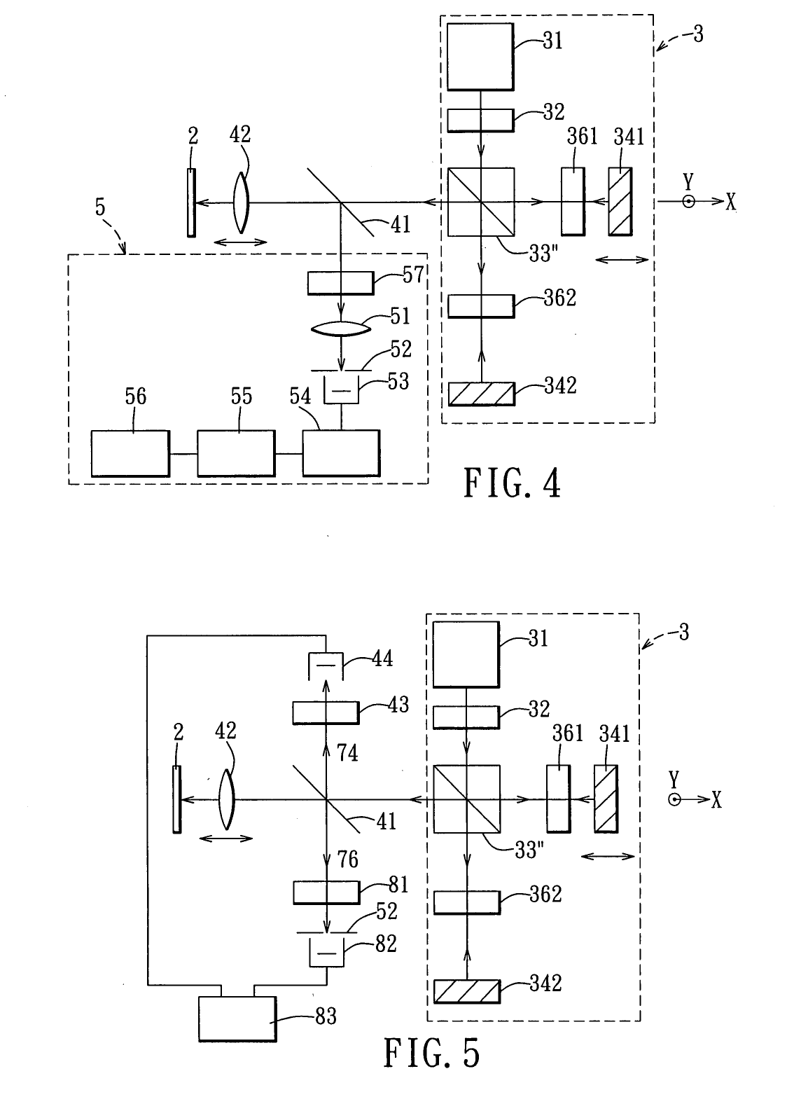

Referring to FIG. 4, the first preferred embodiment of an optical tomography device for implementing the method of the present invention is shown to include a two-frequency beam generating unit 3, a relay beam splitter 41, a focusing lens 42, and a signal processing unit 5.

The two-frequency beam generating unit 3 includes a low-coherence light source 31, such as a super luminescent diode (SLD), and a polarizer 32 capable of adjusting polarization angles for generating a 45° linear polarized beam. The linear polarized beam is split by a polarizing beam splitter (PBS) 33″ into a p-polarization beam and an s-polarization beam, which are hereinafter referred to as a P wave and an S wave, respectively. The S wave is passed through a quarter wave plate (QWP) 361 having an azimuth angle of 45° to become a circular polarized beam. The circular polarized beam is reflected by a mirror 341 that is oscillated back and forth due to the arrangement of a piezo-electric transducer actuator (PZT actuator) so as to generate a Doppler frequency deviation Δω_{D}. The circular polarized beam is further passed through the quarter wave plate 361 to become a P wave for subsequent passage through the polarizing beam splitter 33″. At this time, the frequency of the P wave thus obtained has changed to ω₁=ω₀+Δω_{D}, where ω₀ is the center frequency of the light source 31. The P wave which was originally split by the polarizing beam splitter 33″ is likewise passed through another quarter wave plate 362 having an azimuth angle of 45° to become a circular polarized beam, which is reflected by an immobile mirror 342 for further passage through the quarter wave plate 362 to become an S wave. Since there is not a Doppler effect, the frequency of the S wave thus obtained is ω₂=ω_{D}. The S wave thus obtained is reflected by the polarizing beam splitter 33″, and is combined with the P wave from the quarter wave plate 361 to form a two-frequency (ω₁, ω₂) mutually correlated and mutually orthogonal linear polarized photon-pair low-coherence beam. Without limiting the present invention, the light beam emitted from the two-frequency beam generating unit 3 may also be an elliptical polarized beam, a circular polarized beam, or a non-polarized beam.

Furthermore, the positions of the mirrors 341, 342 must be such that an optical path difference between the reflected light beams is smaller than a coherence length of the light source 31. In this embodiment, the mirror 341 generates oscillation through the piezo-electric transducer actuator, and the piezo-electric transducer actuator is driven by a function generator that outputs fixed frequency signals so that Δω_{D} is fixed and unchanged. Without limiting the present invention, other methods can be used to cause the mirror 341 to oscillate so as to achieve the same effect.

In this embodiment, the present invention is used to measure a scattering medium 2. Accordingly, a low-coherence super luminescent diode is used as the light source 31 so as to obtain a high-resolution sectioning image. Without limiting the present invention, other low-coherence light sources can also be utilized. If a non-scattering medium 2 is to be measured, a high-coherence light source can be used.

In this embodiment, the polarization direction of the polarizer 32 is 45 degrees from both the X-axis and the Y-axis shown in FIG. 4, and the polarizing beam splitter 33″ is disposed for passage of the p-polarization beam there through and for reflecting the s-polarization beam. However, the polarization direction of the polarizer 32 may also be other directions, and the polarizing beam splitter 33″ may also be disposed for passage of the s-polarization beam therethrough and for reflecting the p-polarization beam.

The two-frequency photon-pair beam is then passed through the relay beam splitter 41 and the focusing lens 42 that reciprocates relative to the medium 2 to perform axial scanning and that has a large numerical aperture, and is focused on and reflected by an imaging plane in the scattering medium 2. The reflected signal beam is passed through the focusing lens 42 and reflected by the relay beam splitter 41, and is incident on the signal processing unit 5. In the signal processing unit 5, the incident signal beam is passed through a polarized beam analyzer 57 capable of adjusting a polarization direction angle θs, a lens 51, and a pinhole 52, and is received by a photo detector 53 to result in generation of a heterodyne interference signal.

The definition of the polarization direction angle θs is that the polarization direction of the polarized beam analyzer 57 is θs degrees from the X-axis and is (90−θs) degrees from the Y-axis as shown in FIG. 4.

The lens 51 can focus the signal beam, and the pinhole 52 is located at a focal point of the lens 51 to filter out the signal beam reflected in the medium 2 from an off-focus plane of the focusing lens 42.

Subsequently, the heterodyne interference signal is passed through a band pass filter (BPF) 54 having beat frequency Δω_{D} as a center frequency. The resultant heterodyne interference signal can be expressed as:

I_{sig}(Δωt)=γAₚAₛ sin 2θₛ cos(Δωt+δ_{P}−δ_{S})

where: beat frequency

$$Δ {ω}_{D} = {ω}_{0} \cdot \frac{v}{c} ;$$

the coherence function of the light source 31 is

$$γ = exp [ - {( \frac{2 Δ l \sqrt{ln 2}}{{l}_{ω}} )}^{2} ] ;$$

the speed of the oscillating mirror 341 is

$$v = \frac{\partial ( Δ l )}{\partial t} ,$$

Δl being displacement of the oscillating mirror 341; Δl is the optical path difference of the two-frequency photon-pair beam; l_{w} is the coherence length of the light source 31; Aₚ and Aₛ are amplitudes of the p-polarization signal beam and the s-polarization signal beam, respectively; ω₀ is the center frequency of the beam emitted from the light source 31; c is the speed of light; and δₚ and δₛ are phases of the p-polarization signal beam and the s-polarization signal beam, respectively. Furthermore, since the transmission paths of the p-polarization and s-polarization signal beams are the same, δₚ=δₛ, δ_{P}−δ_{S}≅0.

Thereafter, the filtered electric signal is passed through a linear amplifier 55, and is demodulated using a demodulator 56 to obtain amplitude and phase difference of the signal beam. Alternatively, Hilbert transform is used to demodulate the heterodyne interference electric signal by means of a computer software method, and an amplitude signal and a phase difference signal are displayed on a two-dimensional display device.

In this embodiment, the demodulator 56 is a lock-in amplifier, but may also be substituted by other electronic devices.

When performing tomography scanning on the medium 2, the medium 2 is moved transversely so that the light beam is focused at a certain position of the medium 2. Subsequently, the focusing lens 42 is moved so as to obtain signal beams at different depths at the same transverse position, i.e., performing axial scanning. The signal processing unit 5 is then used to analyze the signal beams reflected from different axial positions of the medium 2 so as to obtain the amplitude and phase difference of the signal beam at each position. Finally, information of each position is put together to result in an axial (X-Z) sectioning image of the medium 2. In a similar manner, lateral scanning can also be performed at the same fixed axial position to obtain a transverse (X-Y) sectioning image.

If the medium 2 has a flow velocity, a sectioning image of the flow velocity of the medium 2 can be obtained by calculating a differential between the phase difference of the signal beams and time using the signal processing unit 5.

During passage of the two-frequency polarized photon-pair beam through the scattering medium 2, due to sensitivity of heterodyne efficiency on the direction of beam propagation and depolarization of polarized beam by the scattering medium 2, the scattering effect can be reduced considerably because of the presence of the polarized beam analyzer 57. In particular, the polarized beam analyzer 57 can be used to filter out large-angle scattering polarized photon-pair beams to form polarization gating and in conjunction with a band pass filter to form coherence gating so as to generate a heterodyne interference signal. Effective collection of more weak scattering photon-pair beams can enhance the signal to noise ratio (SNR) of the signal and the quality of image scanning.

Accordingly, compared with the conventional OCT or OCM in the imaging of a scattering medium, the first preferred embodiment has a better capability to suppress multiple scattering photon-pair beams in imaging of the scattering medium 2, and also has a better capability to collect weak scattering photon-pair beams so as to obtain a preferred SNR. This is because the two-frequency polarized photon-pair beam is propagated along a common transmission path in the scattering medium 2 to result in the generation of the heterodyne interference signal.

In addition, wavefront distortion problems caused by refractive index mismatching, and dispersion and wave aberration can also be counterbalanced due to propagation of the two-frequency polarized photon-pair beam in the medium 2 along a common path. Therefore, the first preferred embodiment permits imaging of the scattering medium 2, and provides better imaging quality. Particularly, the first preferred embodiment provides both axial and lateral resolutions at the same time, and is capable of scanning sectioning images (x-y scan) and tomography (x-z scan). For other optical paths, such as the scattering P wave and S wave, due to the constraint of the low-coherence light source 31, polarized photon-pair beam not within the coherence range cannot effectively generate the heterodyne interference signal, and the band pass filter 54 can be used to filter out the same so as to achieve the object of sectioning images.

Referring to FIG. 5, if the medium 2 has the optical characteristic of linear polarized birefringence, a reference beam 74 can be additionally used to obtain a sectioning image of a phase retardation δ=δₚ₁−δₛ₁ of the medium 2. A portion of the beam from the relay beam splitter 41 is used as the reference beam 74. The reference beam 74 is passed through a polarized analyzer 43 with an azimuth angle θᵣ to result in heterodyne interference, and is further incident on a photo detector 44 to be converted to an electric signal Iᵣ(Δωt)=AₚA_{S} cos(Δωt). A signal beam 76 is also passed through a polarized beam analyzer 81 with an azimuth angle θₛ, and is further incident on a photo detector 82. By using a signal processing unit 83 to analyze the electric signal converted from the signal beam 76 and the reference beam 74 using a signal processing unit 83 for analyzing a phase difference between the beams, a sectioning image of the phase retardation of the medium 2 can be obtained. The signal processing unit 83 may be a lock-in amplifier or a differential amplifier (DA). The advantages offered by a differential amplifier are high SNR and fast speed. The reference beam 74 may be expressed as Iᵣ≈Aₚ₂A_{S2} sin 2θr cos(Δωt). The signal beam 76 may be expressed as Is≈Aₚ₁A_{S1} sin 2θs cos(Δωt+δₚ₁−δₐ₁). By adjusting the angles θᵣ and θₛ, the relation K=Aₚ₁A_{S1} sin 2θs=Aₚ₂A_{S2} sin 2θr can be established. The electric signal after being processed by the differential amplifier can be expressed as

$$\begin{matrix}Δ I = {I}_{s} - {I}_{r} \\ = 2 K sin ( \frac{{δ}_{p 1}}{2} - \frac{{δ}_{s 1}}{2} ) sin ( Δ ω t ) \\ \approx K ( {δ}_{p 1} - {δ}_{s 1} ) sin ( Δ ω t ) .\end{matrix}$$

From the amplitude K(δₚ₁−δₛ₁) of the electric signal, phase retardation δ=δₚ₁−δₛ₁ can be obtained. For more detail in regard to the relevant technical means, reference is made to U.S. Pat. No. 7,006,562.

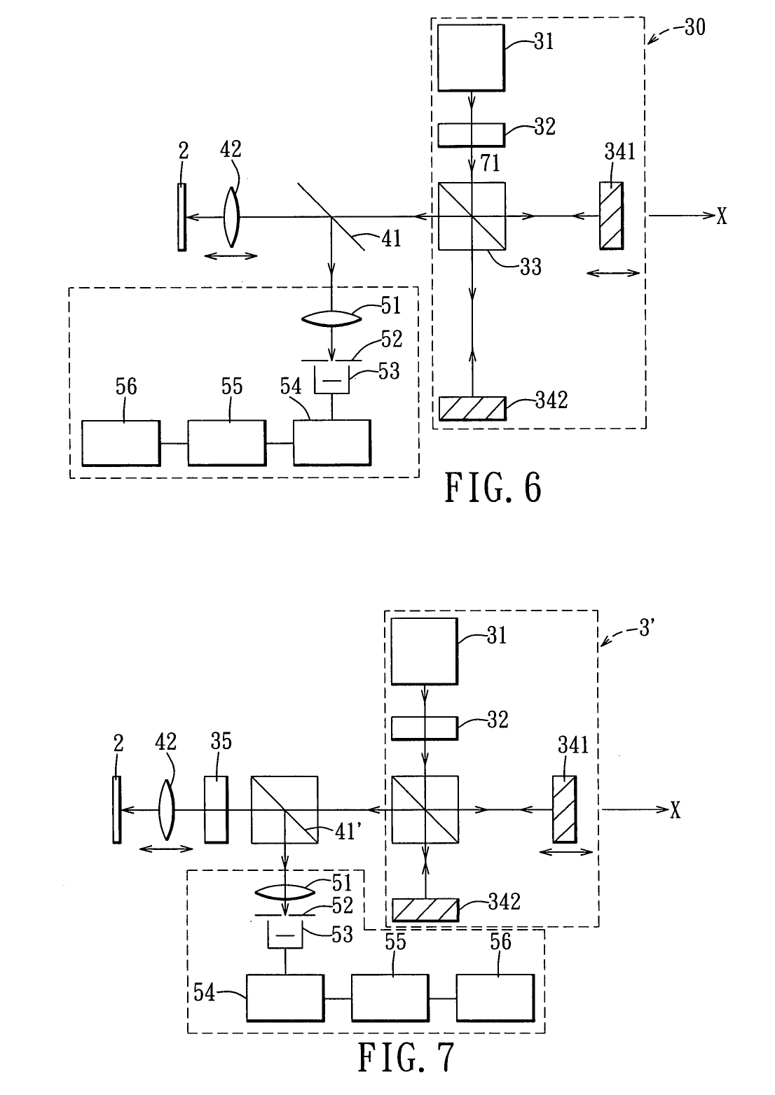

Referring to FIG. 6, the second preferred embodiment of the present invention differs from the first preferred embodiment in that the beam emitted from a two-frequency beam generating unit 30 has parallel polarization directions.

The polarizer 32 is disposed such that the azimuth angle thereof relative to the X-axis is 0° so as to result in generation of the P wave. The P wave is split by a beam splitter 33, such that one portion is reflected by the mirror 341 oscillated by the PZT actuator, and another portion is reflected by the immobile mirror 342, thus resulting in two-frequency parallel P waves, (P₁(ω₁) and P₂(ω₂)), which are incident into the medium 2. The waves reflected from the medium 2 are further reflected by the relay beam splitter 41, and are incident into the photo detector 53 through the lens 51 and the pinhole 52 to result in the heterodyne interference electric signal.

In this embodiment, since the polarization direction of the polarizer 32 is the same as the X-axis shown in FIG. 6, the beam 71 has parallel polarization directions, but may be other linear polarized beams in further embodiments of the invention.

Referring to FIG. 7, the third preferred embodiment of the present invention differs from the first preferred embodiment in that the beam emitted from a two-frequency beam generating unit 3′ is a mutually parallel linear polarized beam (P₁(ω₁)+P₂(ω₂)).

A quarter wave plate 35 having an azimuth angle of 45° modulates mutually parallel P waves into a right-handed or laevo-rotatory polarized beam, but may also modulate the mutually parallel linear polarized beam into a left-handed or dextro-rotatory polarized beam in other embodiments. The laevo-rotatory polarized beam is subsequently incident into the medium 2, is reflected thereby, and is further passed through the quarter wave plate 35 to be converted into mutually parallel S waves, which are reflected by a polarizing beam splitter 41′ and are passed through the lens 51 and the pinhole 52 to the photo detector 53 so as to result in the generation of a heterodyne interference signal.

In this embodiment, since the polarization direction of the polarizer 32 is the same as the X-axis shown in FIG. 7, the beam is a parallel polarized beam. The polarizing beam splitter 41′ is adapted for passage of the parallel polarized beam therethrough and for reflecting an orthogonal polarized beam. The quarter wave plate 35 modulates the parallel polarized beam into a laevo-rotatory polarized beam. However, the polarization direction of the polarizer 32 may also be other directions, and the polarizing beam splitter 41′ may also be disposed for passage of an orthogonal polarized beam therethrough and for reflecting a parallel polarized beam in other embodiments of the invention. The polarizing beam splitter 41′ may also be substituted by a non-polarizing beam splitter.

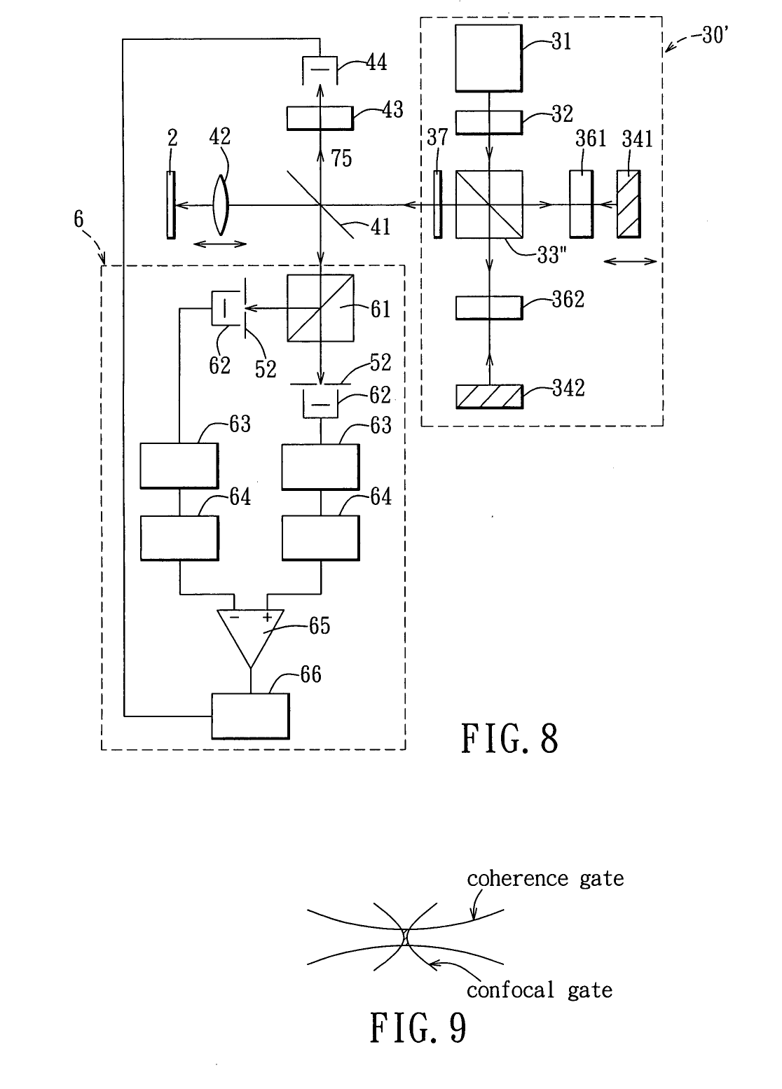

Referring to FIG. 8, the fourth preferred embodiment of this invention differs from the first preferred embodiment in that the light beam emitted from a two-frequency beam generating unit 30′ is a laevo-rotatory polarized beam and a dextro-rotatory polarized beam, and that a differential amplifier 65 is included in a signal processing unit 6 to increase the signal-to-noise ratio and to enhance sensitivity.

In this embodiment, an SLD is used as the light source 31 and is combined with the polarizer 32 in order to achieve the objective of linear polarization. The linear polarized beam is split by the polarizing beam splitter 33″, and is converted to a two-frequency mutually orthogonal linear low-coherence beam based on the same principle as that in the first preferred embodiment. The low-coherence beam is passed through a quarter wave plate 37 having an azimuth angle of 45° so as to result in a two-frequency laevo-rotatory polarized beam and a two-frequency dextro-rotatory polarized beam, which are hereinafter referred to as R wave and L wave in short. The R wave and L wave are further focused on the medium 2 by means of a focusing lens 42 capable of scanning, and are reflected by the medium 2. The laevo-rotatory signal beam and the dextro-rotatory signal beam can be expressed respectively as follows:

$${A}_{R} ( \begin{matrix}1 \\ - i\end{matrix} ) {e}^{i {δ}_{R}} {e}^{l {ω}_{0} t} = [ {A}_{R} {e}^{i {δ}_{R}} ( \begin{matrix}1 \\ 0\end{matrix} ) - {iA}_{R} {e}^{i {δ}_{R}} ( \begin{matrix}0 \\ 1\end{matrix} ) ] {e}^{i {ω}_{0} t} and$$

$${A}_{L} ( \begin{matrix}1 \\ i\end{matrix} ) {e}^{{iδ}_{L}} {e}^{iΔ {ω}_{D} t} {e}^{i {ω}_{0} t} = [ {A}_{L} {e}^{{iδ}_{L}} ( \begin{matrix}1 \\ 0\end{matrix} ) + {iA}_{L} {e}^{{iδ}_{L}} ( \begin{matrix}0 \\ 1\end{matrix} ) ] {e}^{i ( {ω}_{0} + Δ {ω}_{D} ) t}$$

where A_{R} and A_{L} are amplitudes of the laevo-rotatory and dextro-rotatory signal beams, respectively; δ_{R} and δ_{L} are phases of the laevo-rotatory and dextro-rotatory signal beams; ω₀ is the center frequency of the beam emitted from the light source 31; and Δω_{D} is the beat frequency.

The reflected signal beams are received by two photo detectors 62 via the relay beam splitter 41 and a polarizing beam splitter 61 to result in heterodyne interference signals. In particular, the polarizing beam splitter 61 inputs a P wave component (P₁+P₂) and an S wave component (S₁+S₂) of the R wave and the L wave respectively into two photo detectors 62 to result in the generation of heterodyne interference signals, whose magnitudes are:

$$\begin{matrix}{I}_{{P}_{1} + {P}_{2}} ( Δ ω t ) = {\vert {A}_{R} {e}^{i {δ}_{R}} {e}^{i {ω}_{0} t} + {A}_{L} {e}^{i {δ}_{L}} {e}^{i ( {ω}_{0} + Δ {ω}_{D} ) t} \vert}^{2} \\ = {A}_{R}^{2} + {A}_{L}^{2} + 2 {A}_{R} {A}_{L} cos ( Δ ω t + δ )\end{matrix}$$

$$\begin{matrix}{I}_{{S}_{1} + {S}_{2}} ( Δ ω t ) = {\vert {A}_{R} {e}^{i {δ}_{R}} {e}^{i {ω}_{0} t} - {A}_{L} {e}^{i {δ}_{L}} {e}^{i ( {ω}_{0} + Δ {ω}_{D} ) t} \vert}^{2} \\ = {A}_{R}^{2} + {A}_{L}^{2} - 2 {A}_{R} {A}_{L} cos ( Δ ω t + δ )\end{matrix}$$

where δ=δ_{R}−δ_{L}. Besides, since the transmission paths of the laevo-rotatory and dextro-rotatory signal beams are the same, δ_{R}=δ_{L}, and δ≅0.

In this embodiment, the polarizing beam splitter 61 is disposed for passage of parallel polarized beams therethrough and for reflecting orthogonal polarized beams, but may also be disposed for passage of orthogonal polarized beams and for reflecting parallel polarized beams in other embodiments of the invention.

The heterodyne interference signals are further passed respectively through two band pass filters 63 with Doppler frequency deviation Δω_{D} as their center frequency. For the scattering R wave and L wave with other optical paths, heterodyne interference signals cannot be effectively generated because the light source 31 is a low-coherence SLD. Therefore, the band pass filters 63 can be used to filter the heterodyne interference signals to enhance the signal-to-noise ratio.

Thereafter, the heterodyne interference signals are amplified respectively through two linear amplifiers 64, and are inputted into a differential amplifier 65 for subtraction and two-fold amplification. Since the system satisfies conditions of a balanced detector, background noise can be reduced considerably, signal intensity can be increased, and SNR of the system can be enhanced. Thus, the signal outputted by the differential amplifier 65 can be expressed as Iₒᵤₜ(Δωt)=4A_{R}A_{L} cos(Δωt+δ). Axial and lateral scanned sectioning images are displayed on a two-dimensional display through an amplitude demodulator 66.

For the same reason, if the medium 2 has the optical characteristic of circular birefringence, δ=δ_{R}−δ_{L} can be expressed as the phase retardation generated by circular polarization in the medium 2. Therefore, a reference beam 75 can be additionally analyzed. The reference beam 75 is passed through a polarized beam analyzer 43 having an azimuth angle of 0°, and is incident on a photo detector 44 so as to generate a heterodyne interference reference beam Iᵣ(Δωt)≈A_{R}A_{L} cos(Δωt). Likewise, by analyzing the electric signals converted from the signal beam and the reference beam 75 using the amplitude demodulator 66, a sectioning image of the circular birefringence phase retardation of the medium 2 can be obtained.

In sum, the present invention employs a two-frequency mutually correlated low-coherence photon-pair beam, which has a certain beat frequency present therein, so that sectioning images of the scattering medium 2 can be obtained while enhancing the depth resolution and the lateral resolution of three-dimensional sectioning images. In addition, since there are two polarized beams simultaneously incident on the medium 2 along a common path, the refractive index mismatch problems associated with dispersion and aberration will be counterbalanced due to heterodyne interference. Therefore, during tomography scanning, compensation can be automatically performed without knowing in advance the dispersion and aberration caused by the medium 2. Besides, due to the presence of the polarization gating, the spatial coherence gating, the temporal coherence gating, and the spatial filtering gating formed by the pinhole 52, the scattering effect can be considerably reduced, and the axial and lateral spatial resolutions can be enhanced. Furthermore, since axial scanning is performed via the focusing lens 42 to determine the axial scanning position, i.e., the confocal gating overlaps the temporal coherence gating during scanning (see FIG. 9), the difficulty in installing the system can be reduced, and the system can easily obtain a sectioning image by scanning in the axial direction without adopting a dynamic focusing method. Furthermore, the present invention can also be utilized to perform tomography scanning of a phase retardation between mutually parallel or mutually orthogonal two-frequency polarized photon pairs to thereby obtain a phase retardation sectioning image of birefringence optical characteristic, and a Doppler sectioning image.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for optical tomography adapted to measure a medium and comprising the following steps:
(A) generating a two-frequency mutually correlated photon-pair low-coherence beam from a light source, an optical path difference of the beam being smaller than a coherence length of the light source, one of the beam frequencies being changed by an oscillating mirror;
(B) focusing the photon-pair beam on different depth positions of the medium along an optical common path, the beam being reflected by the medium to become a heterodyne interference signal beam; and
(C) analyzing the signal beam reflected by the medium using a signal processing unit so as to obtain a sectioning image of the medium.

2. The method for optical tomography according to claim 1, wherein, in step (C), if the medium has a linear polarized or circular polarized birefringence characteristic, a phase difference of the signal beam is analyzed using one of a lock-in amplifier and a differential amplifier to obtain a sectioning image of phase retardation of the medium.

3. The method for optical tomography according to claim 1, wherein, in step (C), a phase difference of the signal beam can be obtained by the signal processing unit, so that, if the medium has a flow velocity, a sectioning image of the flow velocity of the medium can be obtained by calculating a differential between the phase difference of the signal beam and time.

4. The method for optical tomography according to claim 1, wherein, in step (B), the photon-pair beam is focused by a focusing lens that can be actuated to reciprocate relative to the medium.

5. The method for optical tomography according to claim 1, wherein, in step (A), the beam is a non-polarized beam.

6. The method for optical tomography according to claim 1, wherein, in step (A), the beam has mutually parallel polarization directions.

7. The method for optical tomography according to claim 6, wherein step (A) includes: a sub-step (A1) of modulating a beam into a linear polarized beam; a sub-step (A2) of splitting the linear polarized beam into two linear polarized beams: a sub-step (A3) of reflecting the linear polarized beams using two mirrors, one of the mirrors being actuated to oscillate at a fixed frequency, the mirrors being positioned such that the optical path difference between the reflected linear polarized beams is smaller than the coherence length of the light source; and a sub-step (A4) of causing transmission paths of the reflected linear polarized beams to overlap.

8. The method for optical tomography according to claim 1, wherein, in step (A), the beam is a dextro-rotatory polarized beam or a laevo-rotatory polarized beam.

9. The method for optical tomography according to claim 8, wherein step (A) includes: a sub-step (A1) of modulating a beam into a linear polarized beam; a sub-step (A2) of splitting the linear polarized beam into two linear polarized beams; a sub-step (A3) of reflecting the linear polarized beams using two mirrors, one of the mirrors being actuated to oscillate at a fixed frequency, the mirrors being positioned such that the optical path difference between the reflected linear polarized beams is smaller than the coherence length of the light source; and a sub-step (A4) of modulating the reflected linear polarized beams into one of a laevo-rotatory polarized beam and a dextro-rotatory polarized beam; and wherein step (B) includes: a sub-step (B1) of focusing the photon-pair beam on the medium so that the beam reflected by the medium becomes the signal beam; and a sub-step (B2) of modulating the signal beam into a linear polarized signal beam.

10. The method for optical tomography according to claim 6, wherein the photon-pair beam is focused by a focusing lens in step (B), and step (C) includes: a sub-step (C1) of focusing the signal beam and subsequently filtering out the signal beam which us reflected from an off-focus plane of the focusing lens; a sub-step (C2) of converting the signal beam to an electric signal; a sub-step (C3) of band pass filtering the electric signal to allow passage of beat frequency of the signal beam; a sub-step (C4) of amplifying the electric signal; and a sub-step (C5) of demodulating the electric signal to obtain amplitude and phase difference of the signal beam.

11. The method for optical tomography according to claim 8, wherein the photon-pair beam is focused by a focusing lens in step (B), and step (C) includes: a sub-step (C1) of focusing the signal beam and subsequently filtering out the signal beam which is reflected from an off-focus plane of the focusing lens; a sub-step (C2) of converting the signal beam to an electric signal; a sub-step (C3) of band pass filtering the electric signal to allow passage of beat frequency of the signal beam; a sub-step (C4) of amplifying the electric signal; and a sub-step (C5) of demodulating the electric signal to obtain amplitude and phase difference of the signal beam.

12. The method for optical tomography according to claim 1, wherein, in step (A), the beam has mutually orthogonal polarization directions.

13. The method for optical tomography according to claim 12, wherein step (A) includes: a sub-step (A1) of modulating a beam into a linear polarized beam; a sub-step (A2) of splitting the linear polarized beam into an orthogonal polarized beam and a parallel polarized beam; a sub-step (A3) of modulating the orthogonal polarized beam and the parallel polarized beam into circular polarized beams; a sub-step (A4) of reflecting the circular polarized beams using two mirrors, one of the mirrors being actuated to oscillate at a fixed frequency, the mirrors being positioned such that the optical path difference between the reflected circular polarized beams is smaller than the coherence length of the light source; and a sub-step (A5) of modulating the reflected circular polarized beams into a parallel polarized beam and an orthogonal polarized beam, and causing transmission paths of the modulated beams to overlap.

14. The method for optical tomography according to claim 12, wherein the photon-pair beam is focused by a focusing lens in step (B), and step (C) includes: a sub-step (C1) of causing the signal beam to generate heterodyne interference; a sub-step (C2) of focusing the signal beam and subsequently filtering out the signal beam reflected from an off-focus plane of the focusing lens; a sub-step (C3) of converting the signal beam to an electric signal; a sub-step (C4) of band pass filtering the electric signal to allow passage of beat frequency of the signal beam; a sub-step (C5) of amplifying the electric signal; and a sub-step (C6) of demodulating the electric signal to obtain amplitude and phase difference of the signal beam.

15. The method for optical tomography according to claim 1, wherein, in step (A), the beam is a laevo-rotatory polarized beam and a dextro-rotatory polarized beam.

16. The method for optical tomography according to claim 15, wherein step (A) includes: a sub-step (A1) of modulating a beam into a linear polarized beam; a sub-step (A2) of splitting the linear polarized beam into an orthogonal polarized beam and a parallel polarized beam; a sub-step (A3) of modulating the orthogonal polarized beam and the parallel polarized beam into circular polarized beams; a sub-step (A4) of reflecting the circular polarized beams using two mirrors, one of the mirrors being actuated to oscillate at a fixed frequency, the mirrors being positioned such that the optical path difference between the reflected circular polarized beams is smaller than the coherence length of the light source; a sub-step (A5) of modulating the reflected circular polarized beams into a parallel polarized beam and an orthogonal polarized beam, and causing transmission paths of the modulated beams to overlap; and a sub-step (A6) of modulating one of the parallel polarized beam and the orthogonal polarized beam into the laevo-rotatory polarized beam, and modulating the other one of the parallel polarized beam and the orthogonal polarized beam into the dextro-rotatory polarized beam.

17. The method for optical tomography according to claim 15, wherein step (C) includes: a sub-step (C1) of splitting the signal beam into a two-frequency orthogonal polarized beam having heterodyne interference, and a two-frequency parallel polarized beam having heterodyne interference; a sub-step (C2) of converting the orthogonal polarized beam and the parallel polarized beam respectively to electric signals; a sub-step (C3) of band pass filtering the electric signals to allow passage of beat frequency of the signal beam; a sub-step (C4) of amplifying the electric signals respectively; a sub-step (C5) of subtracting the electric signals; and a sub-step (C6) of demodulating the difference to obtain amplitude and phase difference of the signal beam.

18. A method for optical tomography adapted to measure a medium and comprising the following steps:
(A) generating a two-frequency mutually correlated photon-pair high-coherence beam from a low coherence light source, an optical path difference of the beam being smaller than a coherence length of the light source;
(B) focusing the beam on different depth positions of the medium along an optical common path, the beam being reflected by the medium to become a heterodyne interference signal beam; and
(C) analyzing the signal beam reflected by the medium so as to obtain a sectioning image of the medium.

19. An optical tomography device adapted to measure a medium, comprising:
a two-frequency beam generating unit which emits a two-frequency mutually correlated photon-pair beam, and which includes a light source for emitting a beam, a polarizer for modulating the beam from said light source into a linear polarized beam, a beam splitter for splitting the beam from said polarizer, and two mirrors for reflecting the beams split by said beam splitter respectively, transmission paths of the reflected beams overlapping each other after further passing through said beam splitter, wherein one of said mirrors is actuated to oscillate at a fixed frequency, and said two mirrors are positioned such that an optical path difference between the reflected beams is smaller than a coherence length of said light source;
a relay beam splitter for receiving the photon-pair beam from said beam splitter of said two-frequency beam generating unit;
a focusing lens which is actuatable to move, and which focuses the photon-pair from said relay beam splitter on the medium such that the beam becomes a signal beam after being reflected by the medium, the signal beam being further incident on said focusing lens and said relay beam splitter in sequence; and
a signal processing unit for analyzing the signal beam from said relay beam splitter so as to obtain a sectioning image of the medium.

20. The optical tomography device according to claim 19, further comprising a quarter wave plate disposed between said relay beam splitter and said focusing lens, said relay beam splitter being a polarizing beam splitter, said quarter wave plate modulating the beam from said relay beam splitter into one of a laevo-rotatory polarized beam and a dextro-rotatory polarized beam.

21. The optical tomography device according to claim 19, wherein said signal processing unit includes a lens for focusing the signal beam, a pinhole located at a focal point of said lens, a photo detector, a band pass filter connected electrically to said photo detector, a linear amplifier connected electrically to said band pass filter, and a demodulator connected electrically to said linear amplifier, all of which are arranged in sequence along the transmission path of the signal beam.

22. The optical tomography device according to claim 20, wherein said signal processing unit includes a lens for focusing the signal beam, a pinhole located at a focal point of said lens, a photo detector, a band pass filter connected electrically to said photo detector, a linear amplifier connected electrically to said band pass filter, and a demodulator connected electrically to said linear amplifier, all of which are arranged in sequence along the transmission path of the signal beam.

23. The optical tomography device according to claim 19, wherein said two-frequency beam generating unit further includes two quarter wave plates respectively disposed to receive the split beams from said beam splitter of said two-frequency beam generating unit, said beam splitter of said two-frequency beam generating unit being a polarizing beam splitter, said beam splitter of said two-frequency beam generating unit cooperating with said polarizer to split the beam emitted by said light source into an orthogonal polarized beam and a parallel polarized beam, said quarter wave plates modulating the orthogonal polarized beam and the parallel polarized beam into circular polarized beams, respectively.

24. The optical tomography device according to claim 23, wherein said signal processing unit includes a polarized beam analyzer for adjusting polarization direction angles, a lens for focusing the signal beam, a pinhole located at a focal point of said lens, a photo detector, a band pass filter connected electrically to said photo detector, a linear amplifier connected electrically to said band pass filter, and a demodulator connected electrically to said linear amplifier, all of which are arranged in sequence on the transmission path of the signal beams.

25. The optical tomography device according to claim 23, wherein said two-frequency beam generating unit further includes a quarter wave plate for receiving the parallel polarized beam and the orthogonal polarized beam that are from said beam splitter of said two-frequency beam generating unit, one of the parallel polarized beam and the orthogonal polarized beam being modulated into a laevo-rotatory polarized beam by said quarter wave plate, the other of the parallel polarized beam and the orthogonal polarized beam being modulated into a dextro-rotatory polarized beam by said quarter wave plate.

26. The optical tomography device according to claim 25, wherein said signal processing unit includes a polarizing beam splitter, two photo detectors, two band pass filters connected electrically and respectively to said photo detectors, two linear amplifiers connected electrically and respectively to said band pass filters, a differential amplifier connected electrically to said linear amplifiers, and a demodulator connected electrically to said differential amplifier, said polarizing beam splitter splitting the signal beam into an orthogonal polarized beam and a parallel polarized beam.

27. The optical tomography device according to claim 24, further comprising a polarized beam analyzer, and a photo detector connected electrically to said signal processing unit, a portion of the beam from said relay beam splitter being incident on said photo detector after passing through said polarized beam analyzer.

28. The optical tomography device according to claim 26, further comprising a reference polarized analyzer, and a reference photo detector connected electrically to said signal processing unit, a portion of the beam from said relay beam splitter being incident on said reference photo detector after passing through said reference polarized analyzer.
